(19) United States
(12) Patent Application Publication
(10) Pub. No.: US 2001/0003918 A1
(43) Pub. Date: Jun. 21, 2001

(54) Testing apparatus

(75) Inventor: James Gordon Campbell, Derby (GB)

Correspondence Address: Thomas E. Fisher, Watts, Hoffmann, Fisher & Heinke Co., Suite 1750, 1100 Superior Avenue, Cleveland, OH, 44114-2518, US

(73) Assignee: SureScreen Diagnostics Limited

(21) Appl. No.: 09/735,354

(22) Filed: Dec. 12, 2000

(30) Foreign Application Priority Data
Dec. 10, 1999 (GB) 9929103.1

(51) Int. Cl. G01N 30/90

(52) U.S. Cl. 73/61.54; 210/198.3

(57) ABSTRACT

A testing apparatus in the form of a dip card 10 for testing a fluid medium includes a housing incorporating a grid member 16 provided with openings or tracks 20 for receiving test strips 18. At least one capillary tube 28 communicates between the exterior of the housing and an opening or track 20 in the grid member. The capillary tube 28 enables fluid to pass to a test strip 18 located in the opening 20 in the grid member 16.

### TECHNICAL FIELD AND BACKGROUND OF THE INVENTION

The present invention relates to testing apparatus for testing fluid mediums. A particular application of the invention is in testing urine samples for the presence of drugs.

Drug testing apparatus currently available tends to include chromatography strips mounted within a plastics holder so as to protrude from a base of the holder. These protruding strips are prone to damage or contamination during use or handling, and are not always clean and convenient to use. Alternatively, the chromatography strips may be provided within a plastics sandwich and a base of the whole arrangement dipped into the sample to be analysed.

The chromatography strips may consist of immuno-chromatographic strips manufactured from glass fibre and chromatography paper impregnated with various chemicals such as antibodies, enzymes and dyes.

### SUMMARY OF THE INVENTION

According to the present invention there is provided a testing apparatus for testing a fluid medium, the apparatus comprising a housing provided with test device receiving means and at least one capillary tube communicating between the exterior of the housing and the test device receiving means, the capillary tube enabling fluid to pass to a test device located in said receiving means.

The term “test device” should be understood to include any device which identifies substances in, or properties of, fluid samples to be tested. The test device may comprise a chromatography strip as described above.

Preferably more than one test device receiving means is provided in the housing. The respective receiving means are preferably separated from one another. Preferably separating means are provided in the housing. The housing may include a grid member comprising elongate openings forming the test device receiving means and elongate separator members located between the openings and forming the separating means. The grid member may be bounded by elongate edge members substantially parallel to the separator members and elongate top and base members substantially perpendicular to the separator members. The width of the base member may be between 3 mm and 10 mm and is preferably about 7 mm.

The overall length of the grid member may be between 80 mm and 130 mm, preferably about 105 mm. The overall width of the grid member may be between 30 mm and 70 mm, preferably about 50 mm. The thickness of the grid member may be about 1.5 mm. The width of the channels may be between 4 mm and 6 mm and preferably about 5 mm. The width of the separator members may be between 1 mm and 3 mm and preferably about 2 mm.

The apparatus preferably includes panel members mounted on the grid member to enclose the test device receiving means. The panel members may be substantially planar and may be of approximately the same length and width as the grid member. A front panel member may be provided with means for viewing the receiving means or any test devices contained therein. The viewing means preferably includes an opening or window in the panel member. The front panel member may be provided with a window aligned with each receiving means. Each window may be between 10 mm and 20 mm in length and may be located approximately half way along the length of the panel member.

The apparatus may further include one or more test devices which may comprise immuno-chromatographic strips. The strips may include glass fibre and chromatography paper impregnated with antibodies or other test chemicals. The test devices may be complementary in shape to the receiving means.

The apparatus may further include blocking members for inserting in respective test device receiving means when certain test devices are not used. The blocking members preferably prevent fluid entering the respective receiving means.

Preferably each test device receiving means is adapted to receive a specific test device. Preferably the front panel member is provided with indicia identifying each test device. Preferably the indicia for each test device is located adjacent to the respective viewing means for that test device.

Preferably the test device may provide a positive or negative result for the test. Preferably the result is visible through the viewing means provided in the front panel member. Preferably a control result is also provided by the test device.

Preferably a capillary tube is provided for each receiving means in the housing. Preferably each capillary tube is substantially cylindrical. Preferably the diameter of said capillary tube is between 0.1 to 1 mm and is desirably about 0.8 mm. The capillary tube preferably passes through the base member of the grid member.

Filter means may be provided within one or more capillary tubes. Said filter means preferably filter out debris in fluid medium to be tested. Preferably the filter means comprises a mesh, the size of which may depend on the size of particulates to be filtered.

Preferably the front panel member is provided with a further opening for enabling fluid samples to be applied directly onto test devices in the receiving means.

Preferably the grid member is manufactured from plastics material. The material is preferably impervious. The material is desirably free from moisture and other contaminating products. The material preferably does not interfere with the action of the test devices. The grid member may be manufactured by injection moulding.

Preferably the panel members are mounted on the grid member with an adhesive. Preferably the adhesive is resistant to peeling when placed in a fluid medium. Preferably the adhesive is such that the grid member and housing do not separate in use or storage.

Preferably the adhesive is free from moisture and other contaminating products.

Preferably the panel members are manufactured from a plastics material. The panel members may be manufactured by injection moulding. The panel members may be provided with indicia indicating locations for recording information about the test. Such information may include the time, date and nature of the test. Preferably the indicia are printed onto the panel members. Preferably the printing ink is free from moisture and other contaminating products.

The test devices of the present invention are preferably for use in testing or screening for proteins and other substances in human and animal urine or blood samples; protein and antibodies in milk; harmful bacteria in liquids; or drugs in urine or blood samples.

### BRIEF DESCRIPTION OF THE DRAWINGS

FIG. 1 illustrates schematically a testing apparatus according to the present invention;

FIG. 2 illustrates schematically a front panel of the testing apparatus of FIG. 1;

FIG. 3 illustrates schematically a grid member of the testing apparatus of FIG. 1;

FIG. 4 illustrates schematically a rear panel of the testing apparatus of FIG. 1;

FIG. 5 illustrates schematically an end view of the grid member of FIG. 3;

FIG. 6 illustrates one method of using the apparatus shown in FIG. 1;

FIG. 7 illustrates a further method of using the device shown in FIG. 1;

FIG. 8 illustrates the result obtained from the methods in FIGS. 6 or 7;

FIG. 9 illustrates a further embodiment of the testing apparatus of FIG. 1; and

FIG. 10 illustrates schematically a side view of the apparatus of FIG. 1.

### DESCRIPTION OF THE PREFERRED EMBODIMENT AND BEST MODE

Referring to the drawings, there is provided a testing apparatus in the form of a dip card 10. The dip card 10 is suitable for testing substances in liquid samples, for example drugs in urine samples.

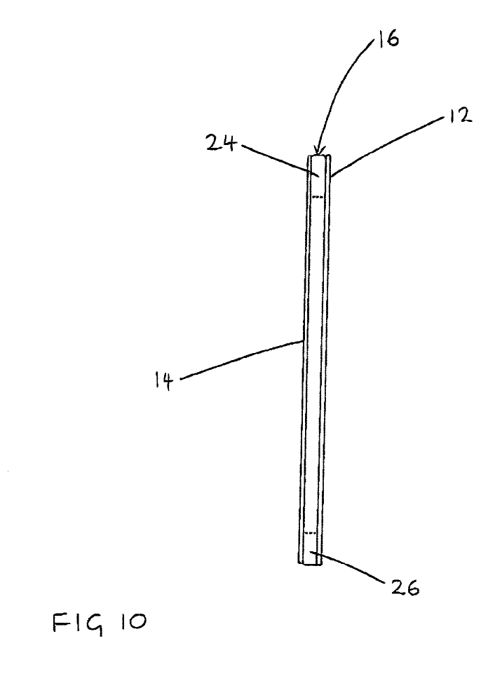

The dip card 10 is constructed from several components, namely front and rear panels 12 and 14, a grid member 16 and test devices in the form of test strips 18. The grid member 16 is sandwiched between the front and rear panels; as illustrated in FIG. 10. In use, the bottom of the dip card 10 is dipped in a liquid sample to be tested, as described in more detail hereinafter.

The grid member 16 is made of plastics material and is generally rectangular is overall shape. The grid member includes a plurality of elongate openings or tracks 20 defined between elongate separator members 22. The grid member 16 is bounded by elongate side members 23, generally parallel to the tracks 20, and top and base members, 24 and 26 respectively which close the tracks at their ends.

The tracks 20 are sized to receive complementary test strips 18. The test strips 18 of the example shown in the figures are for testing the presence of drugs in urine samples. Such drugs may include opiates, cannabis, cocaine and amphetamines amongst others. The test strips 18 consist of prepared enzyme immuno-chromatographic strips manufactured from glass fibre designed individually to portray a positive or negative result of a drug in a urine sample at a prescribed limit. Each strip tests for a respectively different drug.

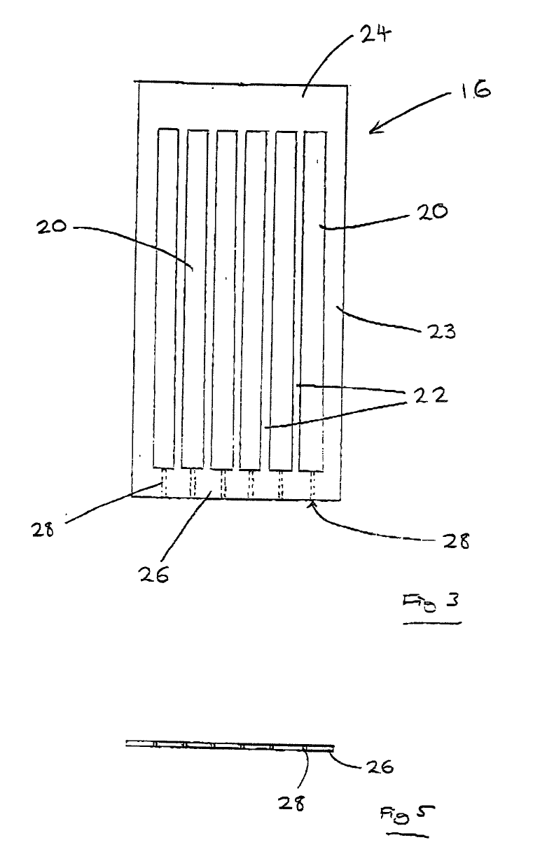

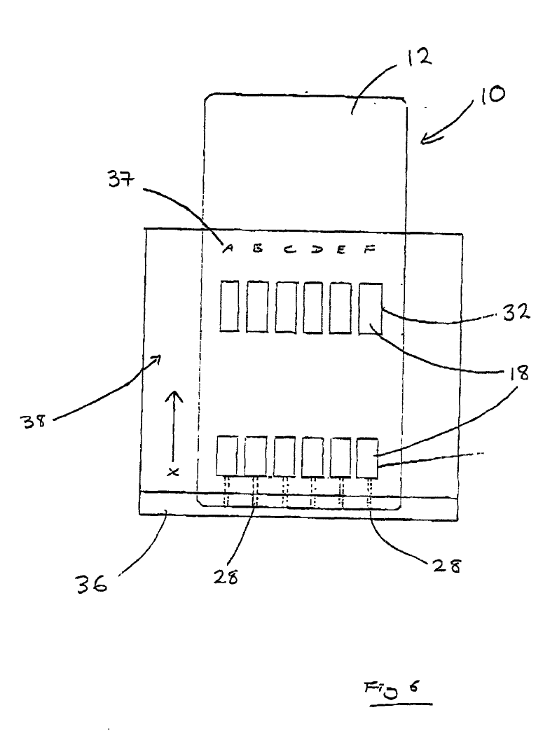

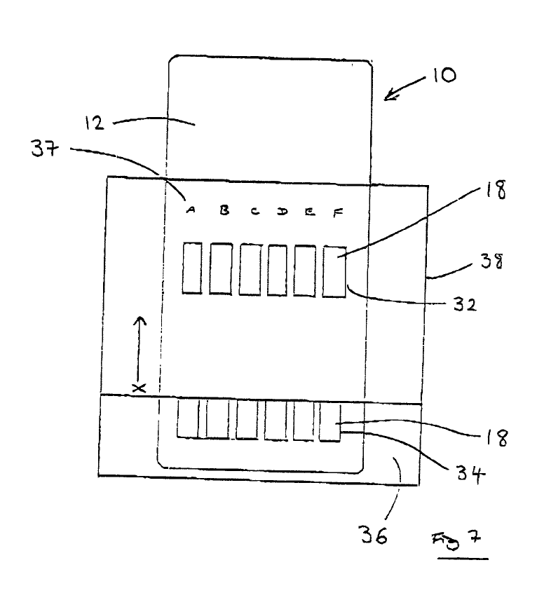

The base member 26 of the grid member 16 is provided with capillaries 28 which enable communication between the exterior of the grid member 26 and the tracks 20. Each capillary communicates between the exterior of the grid member and a respective opening. The capillaries 28 enable fluid to be drawn up to test strips 18 located in the tracks 20, by capillary action as, is illustrated in FIG. 6. The capillaries are of a diameter of between 0.5 to 1 mm. In this example they are 0.8 mm in diameter. The capillaries are best illustrated in FIGS. 3 and 5.

The shapes of the tracks are complementary to those of the test strips. Provided the test strips are a close fit within the tracks 20, fluid from the fluid sample to be tested rises up the test strips by capillary action and is not prevented from undergoing capillary action by any gaps, crevices or tightness associated with the fit of the strips 18 in the grid member 16.

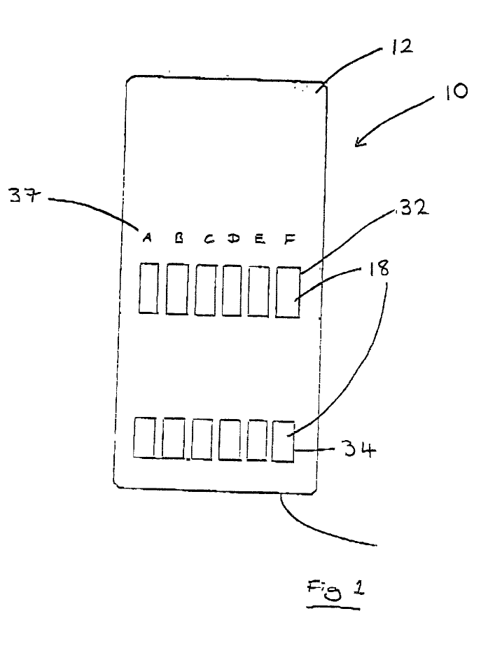

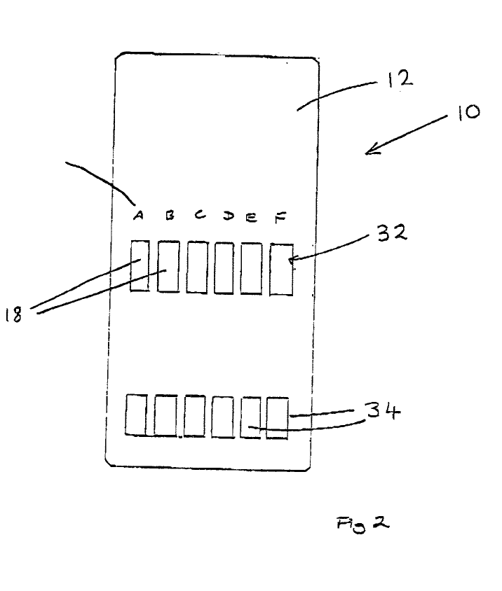

As can be seen in FIGS. 1 and 2 the front panel 12 is provided with windows 32 enabling the test strips 18 to be visible therethrough. Tracks 34 are also provided near a base of the front panel 12. The front panel 12 is also printed with information 37 as required, such as the identification of the tests (A to F) provided by test strips 18 located within the dip card 10.

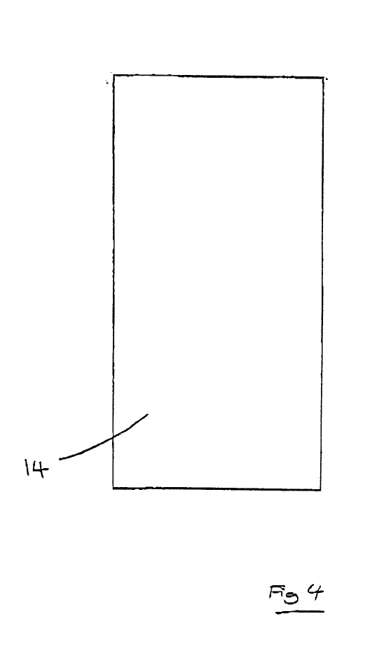

FIG. 4 illustrates the rear panel 14 of the dip card 10. This panel 14 is made of plastics material and can be printed with usage instructions if required.

The dip card 10 can be constructed as follows. Test strips 18 are inserted in to the tracks 20 in the grid member 16, and the grid member sandwiched between the panels 12 and 14. The panels are secured to the grid member 16 by an adhesive. The adhesive should be resistant to peeling such that the dip card 10 remains in tact when dipped in the fluid sample. Furthermore, the adhesive, the panels 12 and 14 and the grid member 16 should be free from any moisture or contaminants which could affect the operation of the test strips 18.

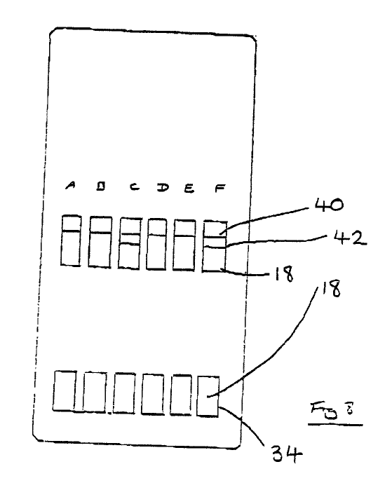

Uses of the dip card 10 are illustrated in FIGS. 6 and 7. Turning first to FIG. 6, this illustrates the use of a card 10 when testing a small volume of urine 36. The level of the urine 36 provided in a beaker 38 is just above the bottom of the card 10. The capillaries 28 provided in the grid member 16 enable urine to rise up into the tracks 20 and hence to the test strips 18 by capillary action. The urine then passes up the test strips 18 by capillary action as indicated by arrow X.

In FIG. 7, the level of urine 36 is above the lower opening 34 of the front panel 12. Therefore, the sample will pass directly onto the test strips 18 or via the capillaries 28 and will again pass up the strips 18 by capillary action as illustrated by arrow X.

Typical results obtained from the dip card 10 are illustrated in FIG. 8. The band 40 corresponds to a control test whereas the test band 42 is indicative of a positive result. Therefore, in this case drugs C and F are present in the urine sample tested.

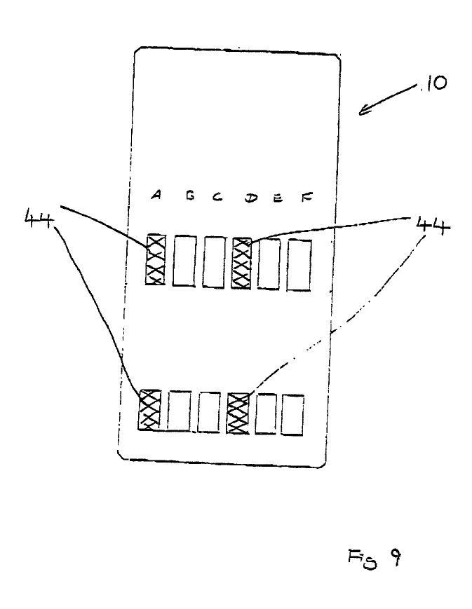

If not all of the tests provided for on the dip card 10 are required (e.g. if not testing for all the drugs), blocking strips 44 can be inserted into the grid member as shown in FIG. 9. These strips 44 prevent urine entering into empty tracks in the grid member 16, and make it immediately apparent that these tracks are not being used for testing.

There is thus described a testing device which provides for numerous advantages. In particular, the device enables small samples of fluid to be tested by providing capillaries within the housing of the device. Furthermore, the provision of blocking strips allows one or more of the tests to be omitted from the device as required by the customer. Therefore, this allows a wide variation of combinations to be supplied and also allows a six panel test to be supplied in any combination of one, two, three, four, five or six tests on the same panel.

The testing device described above is designed for testing for multiple or single drugs in a sample of urine but the design is equally applicable to any combination for any fluid medium suitable for dipping the card into the test fluid medium. Therefore, this application is not limited to drug testing but may be applied to a wide range of test or screening methods, for example protein and sugars in urine, protein and antibodies in milk, harmful bacteria in beer or other liquids.

The number of test receiving means in the housing could be modified such that for example up to twelve different drugs could be tested in any one device by employing a multiple plastic sandwich so that the test strips are exposed on both sides of the test device.

Filters may be provided within the capillaries, to prevent solid impurities from rising onto the test strips.

Whilst endeavouring in the foregoing specification to draw attention to those features of the invention believed to be of particular importance it should be understood that the Applicant claims protection in respect of any patentable feature or combination of features hereinbefore referred to and/or shown in the drawings whether or not particular emphasis has been placed thereon.

1. A testing apparatus for testing a fluid medium, the apparatus comprising a housing provided with test device receiving means and at least one capillary tube communicating between the exterior of the housing and the test device receiving means, the capillary tube enabling fluid to pass to a test device located in said receiving means.

2. A testing apparatus according to claim 1 wherein more than one test device receiving means is provided in the housing, the respective receiving means being separated from one another.

3. A testing apparatus according to claim 2 wherein the housing includes a grid member comprising elongate openings forming the test device receiving means and elongate separator members located between the openings and forming the separating means.

4. A testing apparatus according to claim 3 wherein the apparatus includes panel members mounted on the grid member to enclose the test device receiving means.

5. A testing apparatus according to claim 4 wherein a front panel member is provided with means for viewing the receiving means or any test devices contained therein.

6. A testing apparatus according to claim 5 wherein the viewing means includes an opening or window in the panel member.

7. A testing apparatus according to claim 6 wherein the front panel member is provided with a window aligned with each receiving means.

8. A testing apparatus according to claim 1 wherein the apparatus further includes one or more test devices.

9. A testing apparatus according to claim 8 wherein the test devices comprise immuno-chromatographic strips.

10. A testing apparatus according to claim 1 wherein the apparatus further includes blocking members for inserting in respective test device receiving means when certain test devices are not used. The blocking members preventing fluid entering the respective receiving means.

11. A testing apparatus according to claim 5 wherein the test device may provide a positive or negative result for the test, the result being visible through the viewing means provided in the front panel member.

12. A testing apparatus according to clam 1 wherein a capillary tube is provided for each receiving means in the housing.

13. A testing apparatus according to claim 1 wherein filter means are provided within one or more capillary tubes, said filter means filtering out debris in the fluid medium to be tested.

14. A testing apparatus according to claim 13 wherein the filter means comprises a mesh.
